(19) United States
(12) Patent Application Publication
(10) Pub. No.: US 2009/0140992 A1
(43) Pub. Date: Jun. 4, 2009

(54) DISPLAY SYSTEM

(75) Inventor: Michael Tolaio, Scotts Valley, CA (US)

Correspondence Address: LAW OFFICES OF MIKIO ISHIMARU, 333 W. EL CAMINO REAL, SUITE 330, SUNNYVALE, CA, 94087, US

(73) Assignee: Sunrise Telecom Incorporated, San Jose, CA (US)

(21) Appl. No.: 12/137,512

(22) Filed: Jun. 11, 2008

Related U.S. Application Data
(60) Provisional application No. 60/944,496, filed on Jun. 16, 2007.

(51) Int. Cl. G06F 3/041

(52) U.S. Cl. 345/173

(57) ABSTRACT

A display system including: providing a processor; enabling a touch screen, having a measurement grid, by the processor; pressing a hard key, a soft key, a function tab, a function soft key, the measurement grid, or a combination thereof for activating the touch screen; and displaying a user data on the measurement grid of the touch screen by the processor.

### CROSS-REFERENCE TO RELATED APPLICATION

This application claims the benefit of U.S. Provisional Patent Application Ser. No. 60/944,496 filed Jun. 16, 2007.

### TECHNICAL FIELD

The present invention relates generally to any electronic equipment that conveys information and receives commands through a display, more particularly to a design and implementation aspects of the display system.

### BACKGROUND ART

There exist today many styles of input devices for performing operations in a consumer electronic device. The operations generally correspond to moving a cursor and making selections on a display screen. By way of example, the input devices may include buttons, switches, keyboards, mice, trackballs, touch pads, joy sticks, touch screens and the like. Each of these devices has advantages and disadvantages that are taken into account when designing the consumer electronic device. In handheld computing devices, the input devices are generally selected from buttons and switches. Buttons and switches are generally mechanical in nature and provide limited control with regards to the movement of a cursor (or other selector) and making selections. For example, they are generally dedicated to moving the cursor in a specific direction (e.g., arrow keys) or to making specific selections (e.g., enter, delete, number, etc.). In the case of hand-held personal digital assistants (PDA), the input devices tend to utilize touch-sensitive display screens. When using a touch screen, a user makes a selection on a display screen by pointing directly to objects on the screen using a stylus or finger.

Many forms of electronic equipment use the display screen to communicate information to a user and receive input or command from the user. Test equipment such as a Logic Analyzer, a Spectrum Analyzer, a Digital Storage Oscilloscope (DSO), a Network Analyzer and the like have taken the lead in providing a display system to simplify and enhance the user interface. Other consumer electronic equipment such as a Personal Digital Assistant (PDA), a Global Positioning System (GPS), a Smart Phone, or a Point Of Sale Terminal (POS) may also provide a display as the user interface of choice.

In portable computing devices such as laptop computers, the input devices are commonly touch pads. With a touch pad, the movement of an input pointer (i.e., cursor) corresponds to the relative movements of the user's finger (or stylus) as the finger is moved along a surface of the touch pad. Touch pads can also make a selection on the display screen when one or more taps are detected on the surface of the touch pad. In some cases, any portion of the touch pad may be tapped, and in other cases a dedicated portion of the touch pad may be tapped. In stationary devices such as desktop computers, the input devices are generally selected from mice and trackballs. With a mouse, the movement of the input pointer corresponds to the relative movements of the mouse as the user moves the mouse along a surface. With a trackball, the movement of the input pointer corresponds to the relative movements of a ball as the user rotates the ball within a housing. Both mice and trackballs generally include one or more buttons for making selections on the display screen.

In addition to allowing input pointer movements and selections with respect to a GUI presented on a display screen, the input devices may also allow a user to scroll across the display screen in the horizontal or vertical directions. For example, mice may include a scroll wheel that allows a user to simply roll the scroll wheel forward or backward to perform a scroll action. In addition, touch pads may provide dedicated active areas that implement scrolling when the user passes his or her finger linearly across the active area in the x and y directions. Both devices may also implement scrolling via horizontal and vertical scroll bars as part of the GUI. Using this technique, scrolling is implemented by positioning the input pointer over the desired scroll bar, selecting the desired scroll bar, and moving the scroll bar by moving the mouse or finger in the y direction (forwards and backwards) for vertical scrolling or in the x direction (left and right) for horizontal scrolling.

With regards to touch pads, mice and track balls, a Cartesian coordinate system is used to monitor the position of the finger, mouse and ball, respectively, as they are moved. The Cartesian coordinate system is generally defined as a two dimensional coordinate system (x, y) in which the coordinates of a point (e.g., position of finger, mouse or ball) are its distances from two intersecting, often perpendicular straight lines, the distance from each being measured along a straight line parallel to each other. For example, the x, y positions of the mouse, ball and finger may be monitored. The x, y positions are then used to correspondingly locate and move the input pointer on the display screen.

Electronic touch screens that provide coordinate data regarding the location of an object being brought into proximity to a screen are well known. Typically, keypads are displayed on touch screens to receive user input for application programs. These keypads are comprised of a number of keys that are displayed on a screen. Each keypad typically is defined by two or more corner coordinates and/or length and width parameters. These keypad data define areas on the screen that correspond to particular keys. In response to an object being brought into proximity to the screen, the screen generates location coordinates for the ‘touch’ and a screen control program determines whether the coordinates of the ‘touch’ correspond to one of the defined keypad areas. If they do, the screen control program retrieves input data that correspond to the keypad area that was ‘touched’ and this input data are provided to an application program. Otherwise, no input data are recognized as being generated from the touch screen and exception processing may occur to indicate an erroneous touch to the user.

Typically, a touch screen generates coordinates for a location where an object is brought into proximity to the screen. The screen may be a resistive touch screen that is comprised of two planes of resistive material that are electrically insulated from one another and generally parallel to one another. To detect the location of a touch to the screen, a reference voltage is applied to one of the planes. This plane is called the ‘active’ plane. A location signal for a touch occurs when the force of the touch causes an electrical contact between the two planes and the voltage present at the other plane is measured. With linear resistance in the active plane, the location of the point of contact is directly proportional to the distance the contact point lies from the voltage source. This location gives the proportionate distance along the axis of the active plane. The voltage is then removed from the active plane and applied to the other plane. This action reverses the roles of the two planes so voltage measurement of the other plane provides a proportionate distance along the other axis.

A touch pad may also include sensing electronics for detecting signals associated with electrodes built into its structure. For example, the sensing electronics may be adapted to detect the change in capacitance at each of the electrodes as the finger passes over the grid. The sensing electronics are generally located on the backside of the circuit board. By way of example, the sensing electronics may include an application specific integrated circuit (ASIC) that is configured to measure the amount of capacitance in each of the electrodes and to compute the position of finger movement based on the capacitance in each of the electrodes. The ASIC may also be configured to report this information to a computing device.

Any of these pointing devices may be used to interact with the supporting software of the device. The user may move a pointing device to a certain area of the screen and activate the coordinate structure as previously described. The user interface may then activate a subroutine that responds to the action of the user.

Thus, a need still remains for an efficient display and marker system that can be activated and operated simply and quickly. In view of the increasing demand for the display used in industrial and consumer electronics equipment, it is increasingly critical that answers be found to these problems. Another aspect driving change is the ever-increasing need to save costs and improve efficiencies, makes it more and more critical that answers be found to these problems. Solutions to these problems have been long sought but prior developments have not taught or suggested any solutions and, thus, solutions to these problems have long eluded those skilled in the art.

### DISCLOSURE OF THE INVENTION

The present invention provides a display system including: providing a processor; enabling a touch screen, having a measurement grid, by the processor; pressing a hard key, a soft key, a function tab, a function soft key, the measurement grid, or a combination thereof for activating the touch screen; and displaying a user data on the measurement grid of the touch screen by the processor.

Certain embodiments of the invention have other aspects in addition to or in place of those mentioned above. The aspects will become apparent to those skilled in the art from a reading of the following detailed description when taken with reference to the accompanying drawings.

### BRIEF DESCRIPTION OF THE DRAWINGS

FIG. 1 is a diagram of a display system in an embodiment of the present invention;

FIG. 2 is a block diagram of a display system hardware architecture;

FIG. 3 is a flow chart of a marker activation routine in an embodiment of the present invention;

FIG. 4 is a flow chart of a screen mode selection routine in an embodiment of the present invention;

FIG. 5 is a flow chart of a measurement settings routine in an embodiment of the present invention;

FIG. 6 is a flow chart of a background selection routine in an embodiment of the present invention;

FIG. 7 is a flow chart of a measurement settings storage routine in an embodiment of the present invention;

FIG. 8 is a flow chart of a marker lock routine in an embodiment of the present invention; and

FIG. 9 is a flow chart of a display system for manufacturing the display system in an embodiment of the present invention.

### BEST MODE FOR CARRYING OUT THE INVENTION

The following embodiments of the present invention are described in sufficient detail to enable those skilled in the art to make and use the invention. It is to be understood that other embodiments would be evident based on the present disclosure, and that process or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail. Likewise, the drawings showing embodiments of the apparatus/device are semi-diagrammatic and not to scale and, particularly, some of the dimensions are for the clarity of presentation and are shown greatly exaggerated in the drawing FIGs.

The term “horizontal” as used herein is defined as a plane parallel to the conventional plane or surface of the Earth, regardless of its orientation. The term “vertical” refers to a direction perpendicular to the horizontal as just defined. Terms, such as “above”, “below”, “bottom”, “top”, “side” (as in “sidewall”), “higher”, “lower”, “upper”, “over”, and “under”, are defined with respect to the horizontal plane. The term “on” means there is direct contact among elements. The term “system” as used herein means and refers to the method and to the apparatus of the present invention in accordance with the context in which the term is used. The term “processing” as used herein includes stamping, forging, patterning, exposure, development, etching, cleaning, and/or removal of the material or laser trimming as required in forming a described structure.

The terms keys and buttons are used interchangeably and should be construed broadly. The term physical buttons and hard keys may be used interchangeably. The term soft key may be thought of as a key on a touch screen that is activated by contacting the touch screen in the designated area of the soft key. The term soft key is to be in contrast with the term hard key. Hard keys may be thought of as physical three dimensional keys as opposed to virtual keys on the touch screen. Soft keys, i.e., a corresponding icon, for example, can be located at different positions on a display screen depending on the mode of operation or the actual operation being performed. Hard keys, by contrast, are generally fixed in a specific location, although the function associated with the hard key may be reassigned via various methods. Thus, the terms soft keys and hard keys have relative meaning and soft keys are generally associated with a display and hard keys are generally not.

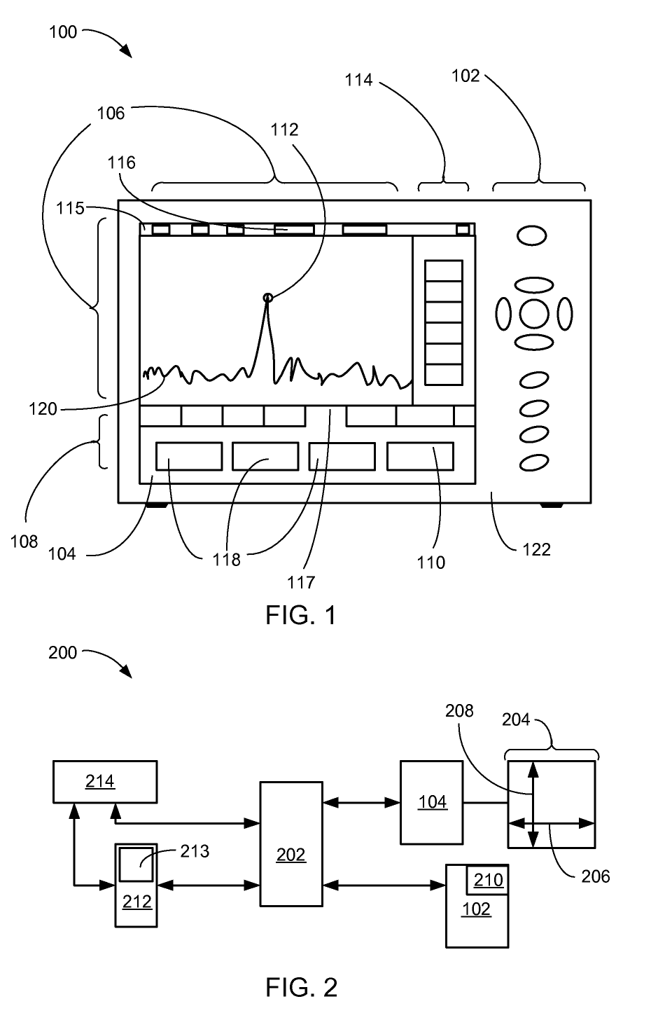

Referring to FIG. 1, therein is shown a diagram of a display system 100 in an embodiment of the present invention. The diagram of the display system 100 depicts hard keys 102, such as the power key, arrow keys, and function select keys, a touch screen 104 having a measurement grid 106, function soft keys 108, a marker lock soft key 110, a marker icon 112, soft keys 114, a menu bar 115, a menu soft key 116, a function tab 117, such as a marker function tab, marker control soft keys 118, user data 120 and a chassis 122.

While test equipment is discussed for this application, other uses will be apparent from the teachings disclosed herein. The layout arrangement and the number of the hard keys 102 may vary depending on the function of the equipment. The touch screen 104 is a tactile display screen and it may be divided into sections. Inside the measurement grid 106, one or more of the marker icon 112 can be displayed when the function tab 117 is selected on the function soft keys 108. The marker icon 112 may use different symbols, color, display intensity, or a combination thereof to indicate marker state of either ACTIVE or ON. In this embodiment example, the ACTIVE marker icon is presented by a box symbol with a higher intensity than the surrounding marker icon. The ON but not ACTIVE marker is presented by a triangle symbol with a normal intensity. This is by way of an example and any combination of color, shape, and intensity that may differentiate the marker icon 112.

The number of the soft keys 114 indicates how many of the marker icon 112 can be on the measurement grid 106 at any time. In this embodiment example, there are six of the soft keys 114. Each of the soft keys 114 is numbered and associated with the marker icon 112 having the same number either next to or inside the marker symbol of either a box or a triangle. The color, shape, and intensity association helps a user to quickly identify the marker icon 112 active location and the soft keys 114 active which shows measured parameters on the marker location.

The function soft keys 108 comprise the function tabs 117 and each tab comprises several of the soft keys 114 for that particular function. In this embodiment example, one of the tab functions is the function tab 117 that includes the marker lock soft key 110 and the marker control soft keys 118. The marker control soft keys 118 may be used to manipulate the position of the marker icon 112 relative to the user data 120. In this embodiment example, the touch screen 104 is locked and unlocked using the marker lock soft key 110. When the touch screen 104 is locked, the screen is not sensitive to a contact or touch, therefore the tactile display is in an inactive mode causing the touch screen to be disabled.

A user is able to unlock the touch screen 104 with a soft key within the touch screen 104, instead of using any one of the hard keys 102 which is away from the user's field of view. If the user desires, various measurement settings may be altered for further data analysis without unlocking the markers. The marker lock soft key 110 is located inside the touch screen 104. In one embodiment example as shown in FIG. 1, the marker lock soft key 110 is placed at the bottom right of the measurement grid 106, within the touch screen 104. This makes user-to-system interaction more efficient because the user does not have to divert attention from the user data 120 on the touch screen 104 as the marker lock soft key 110 is within the user's field of view. The user can comprehend displayed data and quickly lock or unlock the touch screen 104. The reduced time enables the user to devote more time in analyzing the data on the measurement grid 106, thereby increasing the productivity overall.

The menu bar 115 may constantly be displayed on the touch screen 104. The menu bar 115 may have menu soft keys 116, such as file open, file save, screen capture, print, toggle background, full screen, mode selection, system settings, default settings, or exit program. The menu soft keys 116 may be used to perform higher level functions in the display system 100.

Referring now to FIG. 2, therein is shown a block diagram of a display system hardware architecture 200. The block diagram of the display system hardware architecture 200 depicts a processor 202, such as a microprocessor or a micro computer, coupled to the touch screen 104 and the hard keys 102. The processor 202 may provide a map 204 for enabling the touch screen 104 by providing the function tab 117, of FIG. 1, and the soft keys 114, of FIG. 1. The processor 202 may receive an X-coordinate 206 and a Y-coordinate 208 from the touch screen 104 indicating the location touched by the user (not shown). The processor 202 may compare the map 204 with the X-coordinate 206 and the Y-coordinate 208 in order to determine what action to take.

The processor 202 may receive input information from the hard keys 102. This information may be used in combination with the soft keys 114 and the function tabs 117 in order to respond to the user (not shown). The processor 202 may optionally output signals to the hard keys 102 for activating a status feedback device 210, such as a light emitting diode (LED).

A memory 212, such as a non-volatile memory, a high speed memory, or a combination thereof, having a system settings file 213 may be coupled to the processor 202 and a machine interface 214. The system settings file 213 may retain all of the default and current selected parameter settings for the display system 100, of FIG. 1. The machine interface 214 may include a tester, wire-less communication electronics, wired communication electronics, or a combination thereof. The machine interface 214 may transfer tester data to the memory 212 for subsequent display on the touch screen 104. The machine interface 214 may have a connection to the processor 202 for communicating commands or status to a remote user (not shown).

During operation, the user may activate a particular function from the map 204 by touching the location, having the X-coordinate 206 and the Y-coordinate 208, associated with the desired function. The processor 202 may respond to the user's action by causing the machine interface 214 to collect tester data, send a communication message, access parameters in the memory 212, store tester data in the memory, or a combination thereof. The processor 202 may also activate or change the status feedback device 210. The processor 202 may refresh the map 204 with new contents as a result of the function selected by the user.

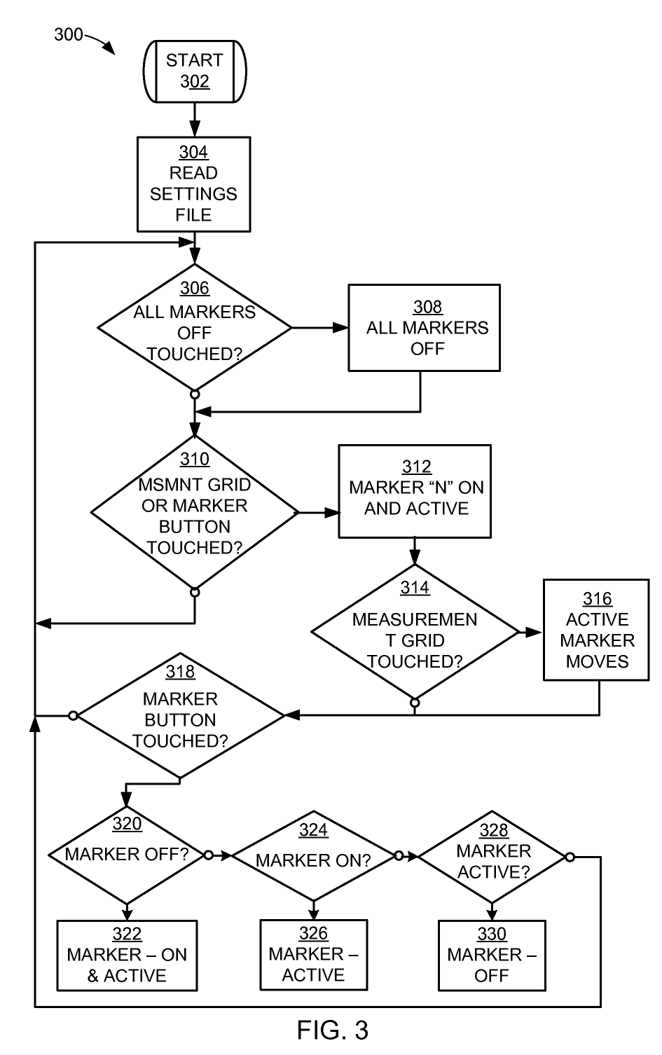

Referring now to FIG. 3, therein is shown a flow chart of a marker activation routine 300 in an embodiment of the present invention. When the system is initially powered on, the marker function is not activated, and the soft keys 114, of FIG. 1, are not displayed as detailed in a START block 302. Information from the system settings file 213 stored in the memory 212, of FIG. 2, is read by the processor 202, of FIG. 2, in a Read Settings File block 304. A first decision block 306 may check for all markers off touched. If the all markers off soft key was touched, the flow progresses to an all markers off block 308. A second decision block 310 is entered from either the first decision block 306 or the all markers off block 308. The second decision block 310 checks to determine if the measurement grid 106, of FIG. 1, or the soft keys 114 has been touched. If neither has been touched, the flow returns to the first decision block 306. If they have been touched the marker “N” is set on and active in a marker active block 312.

A third decision block 314 checks for the measurement grid 106 having been touched. If the measurement grid 106 has not been touched, the flow proceeds to a fourth decision block 318. If the data display window has been touched the flow proceeds to an active marker moves block 316, then progresses to the fourth decision block 318. The fourth decision block 318 monitors for the soft keys 114 to be touched. If the soft keys 114 have not been touched the flow returns to the first decision block 306. If the soft keys 114 have been touched the flow proceeds to a fifth decision block 320 to check for the selected marker in the off state. If the selected marker is found to be off, the flow enters a marker on and active block 322.

If the selected marker is not off, the flow progresses to a sixth decision block 324 to check for the selected marker in an on state. If the selected marker is on, the flow progresses to a marker active block 326. If the selected marker is not on, the flow progresses to a seventh decision block 328 to check for the marker being active. If the selected marker is active the flow progresses to a marker off block 330 where the selected marker is turned off. If the selected marker is found not to be active, the flow returns to the first decision block 306.

At this time, all of the soft keys 114 are shown but only an initial marker becomes active. In this embodiment example, there may be six markers and six delta markers available for most measurement modes. The “active” marker will appear on the touch screen 104, of FIG. 1, as the marker icon 112, of FIG. 1, at the “touched” location, exhibiting a square box, colored and highlighted with the corresponding identifier character, such as a number, an identifying symbol, or a letter. The user data values will appear on the active, highlighted on the soft keys 114 on the touch screen 104. If necessary, the position of the marker can be changed by pressing the left/right arrow keys of the hard keys 102, of FIG. 1. In order to activate a marker other than the marker currently being displayed as “active”, simply touch one of the soft keys 114 to the right of the touch screen 104, this will be detected by the marker activation routine 300. The new marker changes from its former “ON/OFF” status, to its new status as the “active marker”. This means that it can now be moved while the other markers remain in-place. The former “active” marker reverts to an “ON” status, but is no longer the “active” marker.

With “one touch” on the measurement grid 106, at a desired location in which measurement or parameter extraction is to be done, several events happen at the same time including opening the marker control tab, placing the marker icon 112 at the desired location, activating the soft keys 114, making the marker icon 112 the currently active, colored, and highlighted, and recording the user data 120, of FIG. 1, parameter at that location to be placed on the corresponding marker number of the soft keys 114.

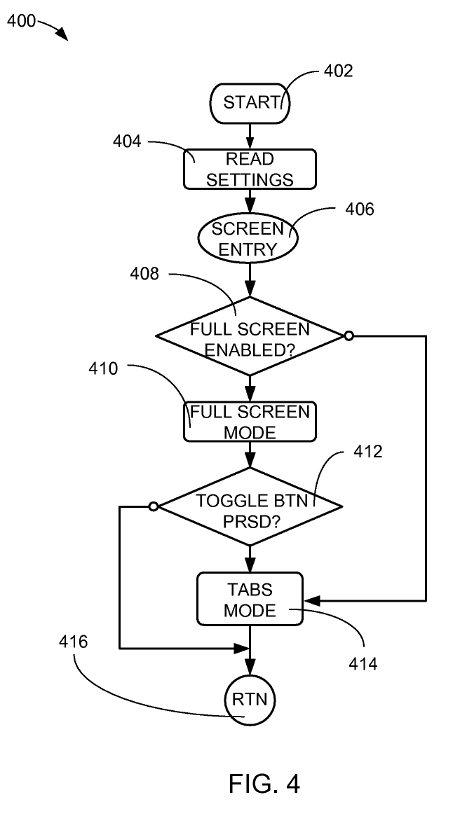

Referring now to FIG. 4, therein is shown a flow chart of a screen mode selection routine 400 in an embodiment of the present invention. The flow chart of the screen mode selection routine 400 depicts a start block 402, such as an initialization entry point, leading to a read settings block 404. In the read settings block 404, the screen mode information may be read from the memory 212, of FIG. 2, by the processor 202, of FIG. 2. The read settings block 404 may be coupled to a screen entry block 406. The screen entry block 406, such as an iterative program entry point, may be the preferred entry point for the screen mode selection routine 400 once the initialization is complete.

A full screen enabled decision block 408 may test the screen mode information to determine whether the full screen mode is enabled. If the test determines that full screen mode is enabled, the flow proceeds to a full screen mode 410. In the full screen mode 410, the processor 202 may modify the map 204, of FIG. 2, to utilize the entire area of the touch screen 104, of FIG. 1, for displaying the user data 120, of FIG. 1, and the function soft keys 108, of FIG. 1. If the test determines that full screen mode is not enabled, the flow proceeds to a tabs mode 414.

From the full screen mode 410, the flow progresses to a toggle button pressed decision block 412. In the toggle button pressed decision block 412, the processor 202 may determine that the menu soft key 116, of FIG. 1, for display toggle has been pressed. This action would signal the user's desire to go to the tabs mode 414. If the menu soft key 116 was not pressed, the flow would enter a return block 416 in order to return control to another program routine.

The tabs mode 414 may be entered by not having full screen enabled or by pressing the function soft keys 108 or the hard key 102 for display toggle. In the tabs mode 414, the processor 202 may generate the map 204 having the function tab 117, of FIG. 1, and the function soft keys 108 on the touch screen 104. From the tabs mode 414, the flow progresses to the return block 416.

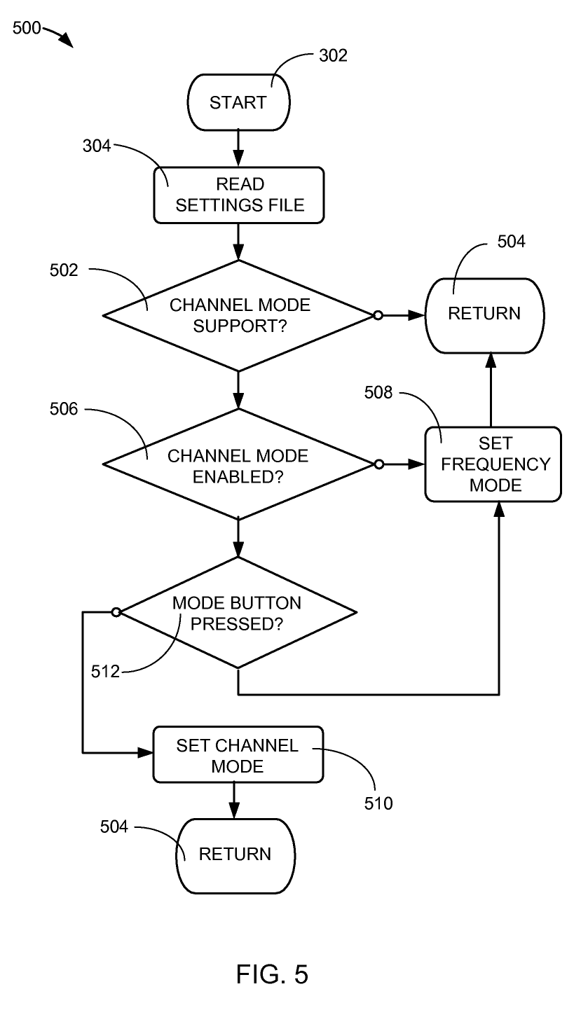

Referring now to FIG. 5, therein is shown a flow chart of a measurement settings routine 500 in an embodiment of the present invention. When the system is initially powered on, the channel mode is not activated as detailed in the START block 302. Information from the system settings file 213, of FIG. 2, stored in the memory 212, of FIG. 2, is read by the processor 202, of FIG. 2, in the Read Settings File block 304.

In a channel mode support decision block 502 the processor 202 may test the contents of the system settings file 213 to determine if channel mode is supported on the display system 100, of FIG. 1. The display system 100 may be configured with many options. If the current configuration does not support the channel mode of operation, the flow will proceed to a return block 504. This path leaves the display system 100 in a default configuration and returns control of the processor 202 to other routines. However if it is determined that the current configuration of the display system 100 does support the channel mode of operation, the flow proceeds to a channel mode enabled decision block 506. In the channel mode enabled decision block 506, the processor 202 may test the system settings file 213 to determine if the channel mode of operation is enabled by the user.

If the channel mode of operation is not enabled by the configuration saved in the system settings file 213, the flow will proceed to a set frequency mode 508. In the set frequency mode 508 the processor 202 may configure the machine interface 214, of FIG. 2, to operate in frequency mode. The processor may also generate the map 204, of FIG. 2, for the touch screen 104, of FIG. 1, that supports the frequency mode of operation.

If the channel mode of operation is enabled by the configuration saved in the system settings file 213, the flow will proceed to a mode button pressed decision block 512. The mode button pressed decision block 512 may cause the processor to determine whether a mode button configured as the hard key 102, of FIG. 1, or the function soft keys 108, of FIG. 1, was pressed by the user. If the processor 202 determines that the mode button was pressed, the flow proceeds to the set frequency mode 508 to configure the tester for frequency mode of operation. The flow then proceeds to the return block 504 which enables the processor 202 to service other events.

If the mode button pressed decision block 512 determines that the mode button was not pressed by the user, the flow proceeds to a set channel mode 510. In the set channel mode 510 the processor 202 may configure the machine interface 214 to operate in channel mode. The processor may also generate the map 204 for the touch screen 104 that supports the channel mode of operation. The flow then proceeds to the return block 504 which enables the processor 202 to service other events.

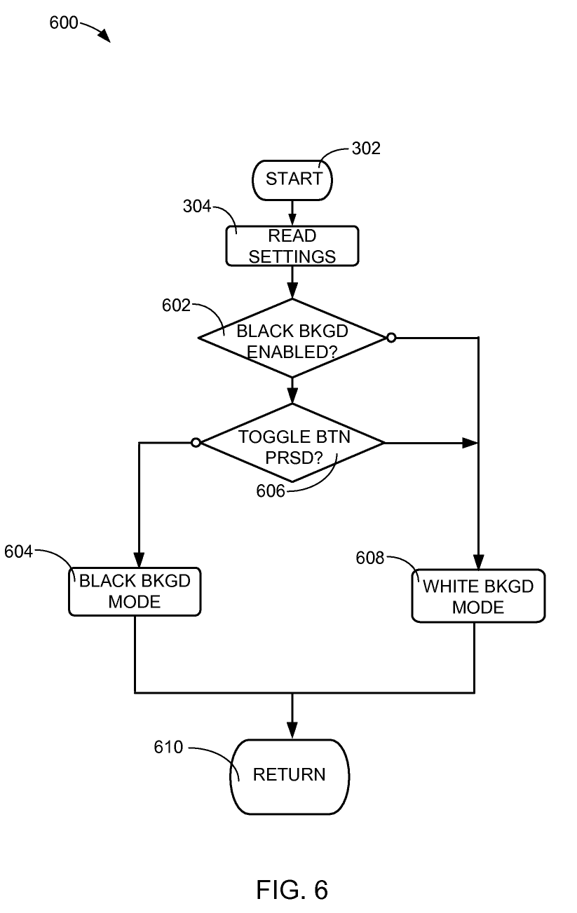

Referring now to FIG. 6, therein is shown a flow chart of a background selection routine 600 in an embodiment of the present invention. When the system is initially powered on, the channel mode is not activated as detailed in the START block 302. Information from the system settings file 213, of FIG. 2, stored in the memory 212, of FIG. 2, is read by the processor 202, of FIG. 2, in the Read Settings File block 304.

In a black background enabled decision block 602, the processor 202 may test the contents of the system settings file 213 to determine if the black background is enabled on the display system 100. If the processor 202 determines that the black background is not enabled, the flow proceeds to a white background mode 608. In the white background mode 608 the processor may generate the map 204, of FIG. 2, for the touch screen 104, of FIG. 1, that supports a white background. The flow then proceeds to a return block 610 which enables the processor 202 to service other events.

If the processor 202 determines that the black background is enabled, the flow proceeds to a toggle button pressed decision block 606. In the toggle button pressed decision block the processor 202 may determine whether a toggle button configured as the menu soft key 116, of FIG. 1, was pressed by the user. If the processor 202 determines that the toggle button was pressed, the flow proceeds to the white background mode 608 to configure the touch screen 104 for the white background. The flow then proceeds to the return block 610 which enables the processor 202 to service other events.

If the processor 202 determines that the toggle button was not pressed, the flow then proceeds to a black background mode 604. In the black background mode 604 the processor may generate the map 204 for the touch screen 104 that supports a black background. The flow then proceeds to the return block 610 which enables the processor 202 to service other events.

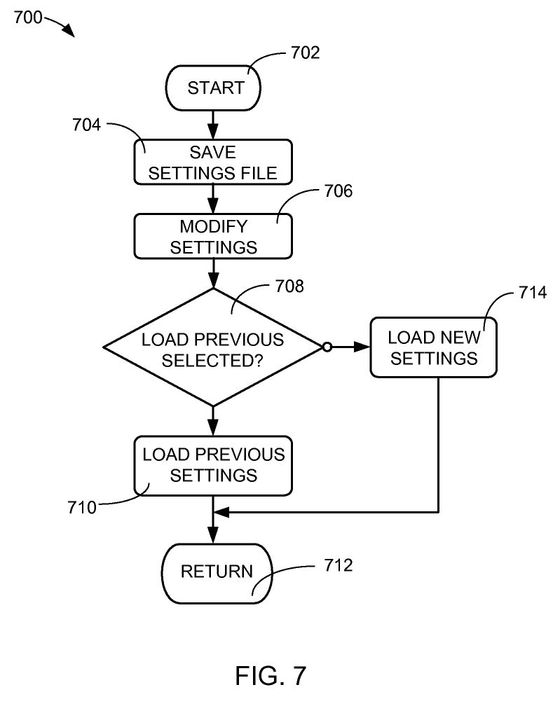

Referring now to FIG. 7, therein is shown a flow chart of a measurement settings storage routine 700 in an embodiment of the present invention. The flow chart of the measurement settings storage routine 700 depicts a start block 702, that may act as an entry point, coupled to a save settings file block 704. In the save settings file block 704 the processor 202, of FIG. 2, may write a new copy of the system settings file 213, of FIG. 2, in the memory 212, of FIG. 2, in preparation for changing those settings. The flow then proceeds to a modify settings block 706. In the modify settings block 706, the processor may configure the machine interface 214, of FIG. 2, to operate with the new settings. The processor may also generate the map 204, of FIG. 2, for the touch screen 104, of FIG. 1, that supports and reflects the new settings used for the operation.

The flow then proceeds to a load previous selected decision block 708. In the load previous selected decision block 708, the processor 202 may determine whether a load previous button configured as the hard key 102, of FIG. 1, or the function soft keys 108, of FIG. 1, was pressed by the user. If the processor 202 determines that the load previous button was pressed, the flow proceeds to a load previous settings block 710 for reading a selected previous version of the system settings file 213 from the memory 212. The previous settings would then be used by the processor 202 to configure the machine interface 214 to operate with the previous settings. The processor 202 may also generate the map 204 for the touch screen 104 that supports and reflects the previous settings used for the operation. The flow then proceeds to a return block 712 in order to return control of the processor 202 to another routine.

If the processor 202 determines that the load previous button was not pressed, the flow proceeds to a load new settings block 714. The new settings would then be used by the processor 202 to configure the machine interface 214 to operate with the new settings. The processor 202 may also generate the map 204 for the touch screen 104 that supports and reflects the new settings used for the operation. The flow then proceeds to the return block 712 in order to return control of the processor 202 to another routine.

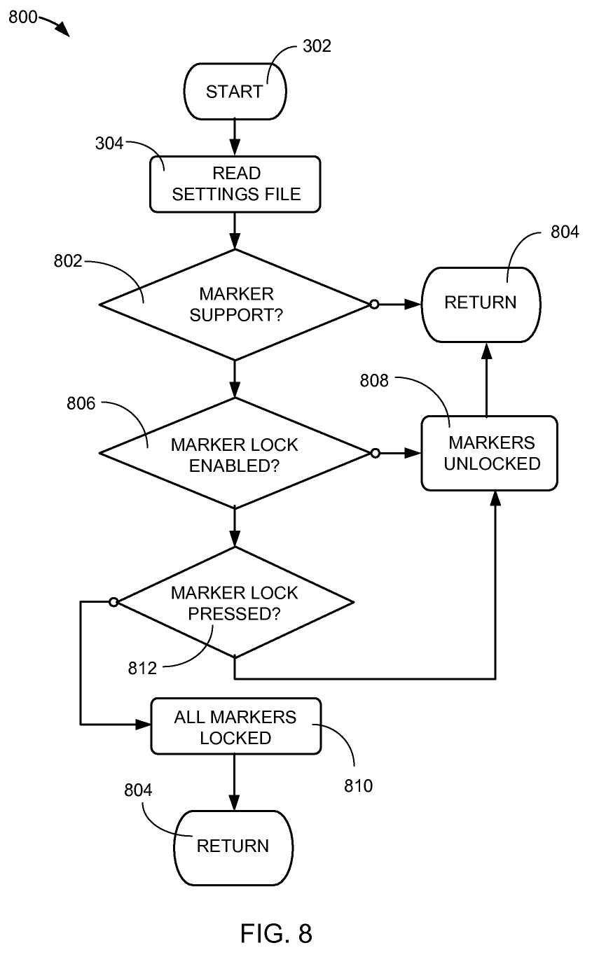

Referring now to FIG. 8, therein is shown a flow chart of a marker lock routine 800 in an embodiment of the present invention. When the system is initially powered on, the channel mode is not activated as detailed in the START block 302. Information from the system settings file 213, of FIG. 2, stored in the memory 212, of FIG. 2, is read by the processor 202, of FIG. 2, in the Read Settings File block 304.

In a marker support decision block 802 the processor 202 may test the contents of the system settings file 213 to determine if markers are supported on the display system 100, of FIG. 1. The display system 100 may be configured with many options. If the current configuration does not support the markers, the flow will proceed to a return block 804. This path leaves the display system 100 in a default configuration and returns control of the processor 202 to other routines. However if it is determined that the current configuration of the display system 100 does support markers, the flow proceeds to a marker lock enabled decision block 806. In the marker lock enabled decision block 806, the processor 202 may test the system settings file 213 to determine if the marker lock is enabled by the user.

If the marker lock is not enabled by the configuration saved in the system settings file 213, the flow will proceed to a markers unlocked block 808. In the markers unlocked block 808 the processor 202 may generate the map 204, of FIG. 2, for the touch screen 104, of FIG. 1, that supports the markers unlocked mode of operation. The flow then proceeds to the return block 804 which enables the processor 202 to service other events.

If the marker lock is enabled by the configuration saved in the system settings file 213, the flow will proceed to a marker lock pressed decision block 812. The marker lock pressed decision block 812 may cause the processor 202 to determine whether a marker lock button configured as the hard key 102, of FIG. 1, or the function soft keys 108, of FIG. 1, was pressed by the user. If the processor 202 determines that the marker lock button was pressed, the flow proceeds to the markers unlocked block 808 to configure the touch screen 104 for the markers unlocked mode of operation. The flow then proceeds to the return block 804 which enables the processor 202 to service other events.

If the processor 202 determines that the marker lock button was not pressed, the flow proceeds to an all markers locked block 810. In the all markers locked block 810 the processor 202 may generate the map 204 for the touch screen 104 that supports the all markers locked mode of operation. The flow then proceeds to the return block 804 which enables the processor 202 to service other events.

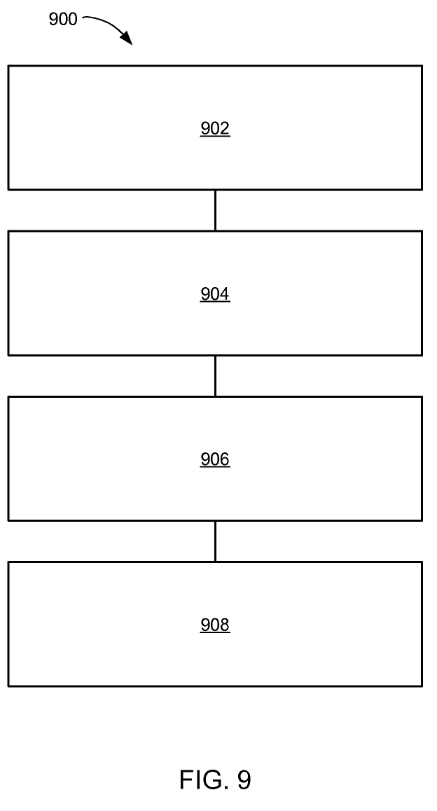

Referring now to FIG. 9, therein is shown a flow chart of a display system 900 for manufacturing the display system 100 in an embodiment of the present invention. The system 900 includes providing a processor in a block 902; enabling a touch screen, having a measurement grid, by the processor in a block 904; pressing a hard key, a soft key, a function tab, a function soft key, the measurement grid, or a combination thereof for activating the touch screen in a block 906; and displaying a user data on the measurement grid of the touch screen by the processor in a block 908.

Thus, it has been discovered that the display system of the present invention furnishes important and heretofore unknown and unavailable solutions, capabilities, and functional aspects for display systems. The resulting processes and configurations are straightforward, cost-effective, uncomplicated, highly versatile and effective, can be surprisingly and unobviously implemented by adapting known technologies, and are thus readily suited for efficiently and economically manufacturing display system devices fully compatible with conventional manufacturing processes and technologies. The resulting processes and configurations are straightforward, cost-effective, uncomplicated, highly versatile, accurate, sensitive, and effective, and can be implemented by adapting known components for ready, efficient, and economical manufacturing, application, and utilization.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A display system including:
providing a processor;
enabling a touch screen, having a measurement grid, by the processor;
pressing a hard key, a soft key, a function tab, a function soft key, the measurement grid, or a combination thereof for activating the touch screen; and
displaying a user data on the measurement grid of the touch screen by the processor.

2. The system as claimed in claim 1 further comprising providing a menu bar on the touch screen for configuring the measurement grid.

3. The system as claimed in claim 1 further comprising providing a memory coupled to the processor for storing a system settings file.

4. The system as claimed in claim 1 further comprising executing a marker activation routine by the processor.

5. The system as claimed in claim 1 further comprising:
providing a machine interface coupled to the processor; and
executing a measurement settings routine by the processor for configuring the machine interface.

6. A display system including:
providing a processor for generating a map;
enabling a touch screen, having a measurement grid, by the processor including providing a soft key and a function tab;
pressing a hard key, the soft key, the function tab, a function soft key, the measurement grid, or a combination thereof for activating the touch screen including receiving an X-coordinate and a Y-coordinate by the processor; and
displaying a user data on the measurement grid of the touch screen by the processor including executing a full screen mode or a tabs mode.

7. The system as claimed in claim 6 further comprising providing a menu bar on the touch screen for configuring the measurement grid by pressing a menu soft key for executing a black background mode or a white background mode by the processor.

8. The system as claimed in claim 6 further comprising providing a memory coupled to the processor for storing a system settings file including executing a measurement settings storage routine by the processor.

9. The system as claimed in claim 6 further comprising executing a marker activation routine by the processor including positioning a marker icon on the measurement grid, activating the marker icon, turning off the marker icon, or a combination thereof.

10. The system as claimed in claim 6 further comprising:
providing a machine interface coupled to the processor including providing a tester, wire-less communication electronics, wired communication electronics, or a combination thereof; and
executing a measurement settings routine by the processor for configuring the machine interface including switching a set frequency mode or a set channel mode for configuring the machine interface.

11. A display system including:
a processor;
a touch screen, having a measurement grid, enabled by the processor;
a hard key, a soft key, a function tab, a function soft key, the measurement grid, or a combination thereof for activating the touch screen; and
a user data displayed on the measurement grid of the touch screen by the processor.

12. The system as claimed in claim 11 further comprising a menu bar on the touch screen for configuring the measurement grid.

13. The system as claimed in claim 11 further comprising a memory coupled to the processor for storing a system settings file.

14. The system as claimed in claim 11 further comprising a marker icon on the measurement grid managed by the processor.

15. The system as claimed in claim 11 further comprising a machine interface coupled to the processor for configuring a measurement settings routine.

16. The system as claimed in claim 11 further comprising:
a map generated by the processor;
an X-coordinate and a Y-coordinate transferred from the touch screen to the processor; and
a full screen mode or a tabs mode for displaying the user data on the measurement grid.

17. The system as claimed in claim 16 further comprising a menu bar on the touch screen for configuring the measurement grid by a menu soft key to switch a black background mode or a white background mode by the processor.

18. The system as claimed in claim 16 further comprising a memory coupled to the processor for storing a system settings file includes a measurement settings storage routine executed by the processor.

19. The system as claimed in claim 16 further comprising a marker icon on the measurement grid managed by the processor includes a marker icon positioned on the measurement grid, the marker icon activated, the marker icon turned off, or a combination thereof.

20. The system as claimed in claim 16 further comprising a machine interface coupled to the processor includes a tester, wire-less communication electronics, wired communication electronics, or a combination thereof.
